(19) United States
(12) Patent Application Publication
(10) Pub. No.: US 2021/0071635 A1
(43) Pub. Date: Mar. 11, 2021

(54) VERTICAL WIND TURBINE WITH ROTATABLE BLADES

(71) Applicant: Kan Cheng, Newark, CA (US)

(72) Inventor: Kan Cheng, Newark, CA (US)

(21) Appl. No.: 16/563,921

(22) Filed: Sep. 8, 2019

(51) Int. Cl. F03D 3/06; F03D 7/06; F03D 3/00

(52) U.S. Cl. CPC F03D 3/067; F03D 3/005; F03D 7/06

(57) ABSTRACT

A vertical wind turbine with rotatable wind blades. Under wind pressure, each blade is capable to rotate and stop at a specified location for optimal angle of attack towards the wind to improve the efficiency of the turbine.

Each blade is divided into two unequal area of airfoils with the aerodynamic center of the blade located in the larger area trail end. Under wind pressure, the turbine frame would stop the blades at locations where each blade has an optimal angle of attack towards the wind. As a result, blades in the upwind force zone encounter minimal drag force to improve the efficiency of the turbine.

### TECHNICAL FIELD

The present invention generally relates to a wind turbine, and more specifically to a vertical axis wind turbine. Further, the present invention relates to a vertical wind turbine with rotatable blades.

### BACKGROUND

A vertical wind turbine has a structure with some of its wind blades rotating upwind (refer to as upwind blades) and others rotating downwind (downwind blades). Effective force for torque generation of the vertical turbine is the force generated by downwind blades (downwind force) minus the force generated by upwind blades (upwind force). The upwind force makes a vertical turbine less efficient than a horizontal axis wind turbine which has all blades uniformly rotating downwind.

A vertical turbine can increase its efficiency, if the upwind force could be reduced.

### SUMMARY OF THE INVENTION

A Vertical Wind Turbine with Rotatable Blades (VWTWRB) has all its wind blades mounted on rotatable pivots. Wind power drives each blade to rotate and stop at its optimal position, so that upwind force can be reduced and efficiency of VWTWRB can be improved.

Each blade of VWTWRB has a rotatable pivot axis (pivot axis) embedded within the airfoil of the blade and the pivot axis divides the blade into two unequal area of airfoils. When wind blows to the blade, the larger trail end airfoil of the blade (trail end) receives more drag force than the smaller lead end airfoil of the blade (lead end). Because the aerodynamic center of the blade is located within the trail end, the trail end dominates the rotating of the blade around the pivot axis.

Under wind pressure, a blade could rotate to a position with the trail end aligned toward downwind direction as one of a stable state, else it could rotate and stop by an object to form another type of stable state. All blades would rotate from various unstable states and stop to one of the stable states.

As a result, after all blades stop and settle to their designated stable states, the VWTWRB would encounter minimum upwind force for optimum efficiency.

### BRIEF DESCRIPTION OF THE DRAWINGS

FIG. 1 shows an expanded view of a VWTWRB embodiment with a stationary vertical center axis (center axis), an elongated cube shaped cage turbine frame (frame), four wind blades (blades), four pivot axes and an output pulley in accordance with an embodiment.

FIG. 2 shows a top view of a blade assembly installed on a frame with arrowheads and text “wind” to present incident wind. The blade has its trail end towards to the upwind direction with an arrowhead marked with text “F” passing through its aerodynamic center and an arced arrowhead marked with text “rotating” to present the rotating direction of the blade in accordance with an embodiment.

FIG. 3 shows a top view of a blade assembly installed on a frame. The blade is aligned to the wind direction with its chord line presented by a dotted line. An arrowhead passing by the aerodynamic center of the blade and marked with text “drag”, the arrowhead points to downwind or the trail end of the blade in accordance with an embodiment.

FIG. 4 shows a top view of a blade assembly installed on a frame. Under wind pressure, the blade is stopped from rotating by a vertical beam (beam) nearby the trail end. The location of the beam is underneath the frame and marked with a dotted circle. A setting angle is presented by two crossed dotted lines and marked with text “45°” in accordance with an embodiment.

FIG. 5 shows a top view of a blade assembly installed on a frame. Under wind pressure, the blade is stopped from rotating by a beam nearby the lead end. The location of the beam is underneath the frame and marked with a dotted circle. A setting angle is presented by two crossed dotted lines and marked with a text “45°” in accordance with an embodiment.

FIG. 6 is a top view of a VWTWRB embodiment overlapped with a polar coordinates reference and a circular arrowhead nearby the center axis to indicate a counter clockwise (CCW) rotating frame. Four blade assemblies marked with number (#) “1” to “4” with each blade location identified by its pivot axis position. For example, blade #1 is at 0° reference point. Each blade has a vector analysis graph overlap to its aerodynamic center in accordance with an embodiment.

FIG. 7 shows a VWTWRB embodiment CCW rotated 22.5° with blade #1 located at 22.5° reference point in accordance with an embodiment.

FIG. 8 shows a VWTWRB embodiment CCW rotated another 22.5° with blade #1 located at 45° reference point in accordance with an embodiment.

FIG. 9 shows a VWTWRB embodiment CCW rotated another 22.5° with blade #1 located at 67.5° reference point in accordance with an embodiment.

FIG. 10 shows a VWTWRB embodiment CCW rotated another 22.5° with blade #1 located at 90° and blade #4 located at 0° reference point in accordance with an embodiment.

FIG. 11 shows a VWTWRB embodiment overlapped with two angular zone references indicated by two dotted circular arrowheads; one zone starts from −45° to 45° marked with text “90° upwind force zone” and another zone starts from 45° to −45° marked with text “270° downwind force zone” in accordance with an embodiment.

### DESCRIPTION OF THE EMBODIMENTS

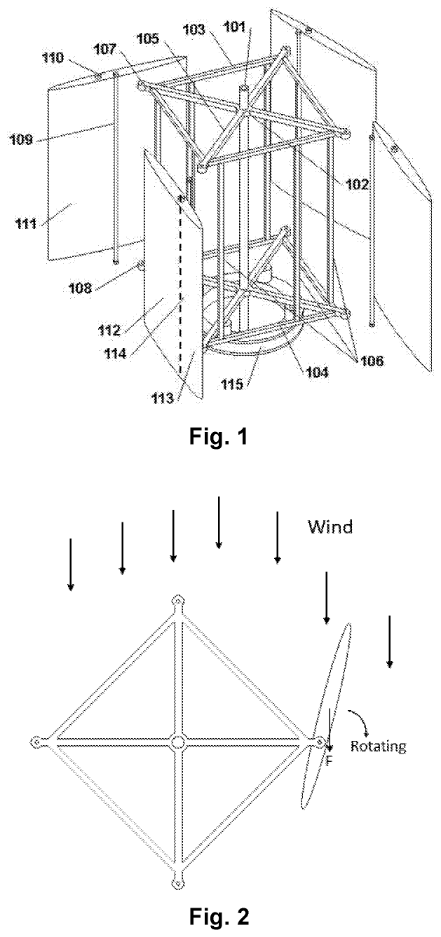

FIG. 1 represents an expanded view of VWTWRB embodiment with a frame 102 mounted on a center axis 101. The frame is structured with a square shaped upper deck 103 and a duplicated lower deck 104, each deck has four diagonal arms (arm) 105 that connect from corners of the deck to the center axis with a hidden ball bearing and the frame is rotatable around the center axis. Two decks connect to each other with eight vertical beams 106. There are four mounting holes 107 at the ends of the arms of the upper deck and four mounting holes 108 at the ends of the arms of the lower deck, these mounting holes are vertically paired and aligned, so blade assemblies can be mounted on the frame through these paired mounting holes.

Each blade assembly is made of a pivot axis 109 passing through a blade mounting hole 110 of the blade 111. The pivot axis divides a blade into two unequal area airfoils; a larger trail end airfoil (trail end) 112 and a smaller lead end airfoil (lead end) 113. A dotted reference line 114 indicates this division in reference to the blade mounting hole.

An output pulley 115 is mounted on the bottom of the lower deck to output the torque for power generation.

Under wind pressure, trail end of a blade generates more aerodynamical force than the lead end and the aerodynamic center is located at the trail end; said trail end dominates the rotation of the blade. FIG. 2 represents a blade under an unstable state with its trail end pointing to the upwind. When wind generated force (wind force) is applied to its aerodynamic center, the blade will rotate around the pivot axis with the rotating direction indicated by an arced arrowhead.

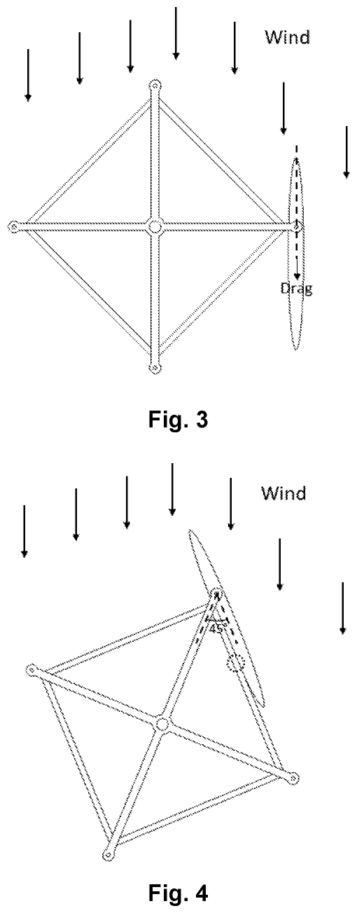

FIG. 3 represents a blade with wind force applied to its aerodynamic center. Because the chord line of the blade has a 0° angle of attack (AOA) with the wind direction, it has a small cross-section towards the wind and generates minimal drag force. The blade is under an aerodynamic stable state and this state is defined as “stable 1 state”.

FIG. 4 represents a rotating blade stopped by a beam at the trail end of the blade. The location of the beam is used to set the chord line of the blade with the arm to form a 45° setting angle. The blade is under a stable 2 state and the stableness of the blade is supported by the pivot axis and the beam.

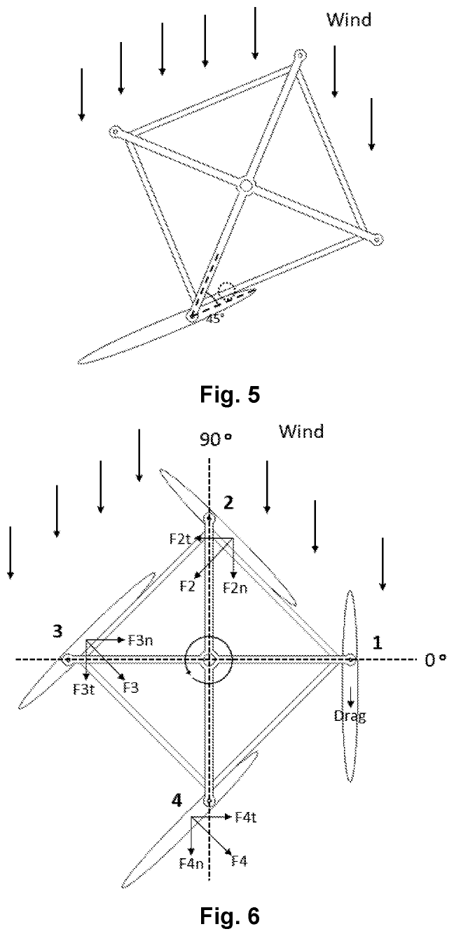

FIG. 5 represents a rotating blade stopped by a beam at the lead end of the blade. The location of the beam is used to set the chord line of the blade with the arm to form a 45° setting angle. The blade is under a stable 3 state and the stableness of the blade is supported by the pivot axis and the beam.

FIG. 6 to FIG. 10 represent a static study of wind forces applied to each blade at four locations with the frame rotating from 0° to 90°. Because the VWTWRB has a symmetrical structure, blades repeat their responses to the wind every 90° cyclically. The study divides 0° to 90° into four equivalent angular divisions and analyzes forces applied to each blade at 0°, 22.5°, 45° and 67.5°.

FIG. 6 represents blade #1 at 0° reference point with the trail end pointing downwind; it is in a stable 1 state. Blade #2 is in a stable 2 state; similar to a sail of a sailboat, wind forces applied to blade #2 can be presented by a force passing through its aerodynamic center with a normal direction to its chord line. The incident wind force is presented by F2. F2 is a vector sum of F2t and F2n, where:

F2t=F2×Cosine 45°; F2t is a tangential force applied to the arm.
F2n=F2×Sine 45°; F2n is a normal force applied to the center axis.

Similar to blade #2, blade #3 is in a stable 2 state. Wind forces applied to blade #3 is presented by F3 and F3 is a vector sum of F3t and F3n, where;

F3t=F3×Cosine 45°; F3t is a tangential force applied to the arm.
F3n=F3×Sine 45°; F3n is a normal force applied to the center axis.

Blade #4 is in a stable 3 state. Wind forces applied to blade #4 is presented by F4 and F4 is a vector sum of F4t and F4n, where;

F4t=F4×Cosine 45°; F4t is a tangential force applied to the arm.
F4n=F4×Sine 45°; F4n is a normal force applied to the center axis.

All normal forces are nulled by stationary center axis and all tangential forces applied to arms have a vector sum of F2t+F3t+F4t for torque generation of WTWRB.

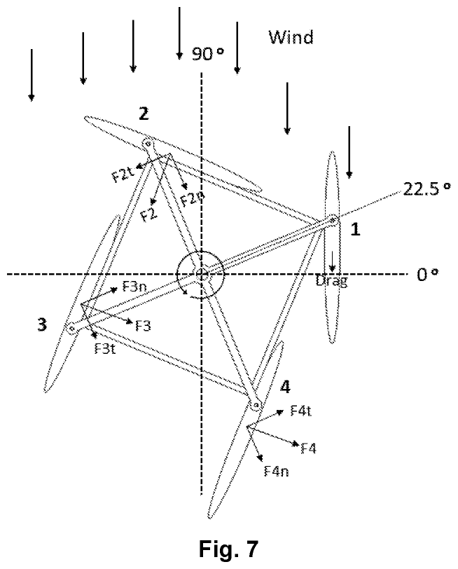

FIG. 7 represents a frame after 22.5° rotation and blade #1 is at 22.5° reference point. FIG. 7 is similar to FIG. 6 but incident wind forces F2, F3, F4 changed following the rotation of the frame. Total tangential forces applied to arms have a vector sum of F2t+F3t+F4t for torque generation of VWTWRB.

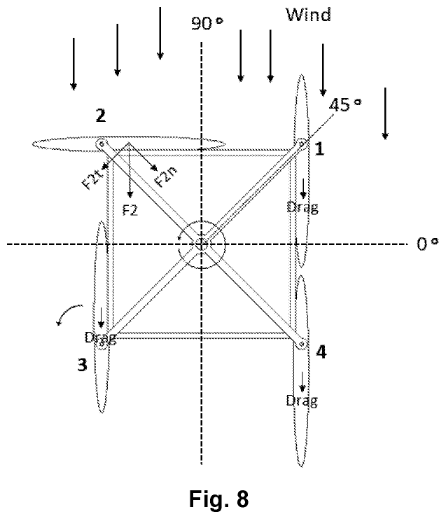

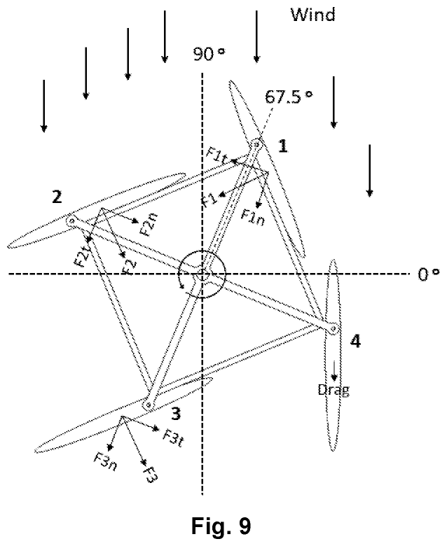

FIG. 8 represents a frame after another 22.5° rotation and blade #1 is at 45° reference point. Both blade #1 and #4 are in stable 1 state with minimal drag and blade #2 is in a stable 2 state. Wind forces applied to blade #2 is presented by F2 and F2 is a vector sum of F2t and F2n, where:

F2t=F2×Cosine 45°; F2t is a tangential force applied to the arm.
F2n=F2×Sine 45°; F2n is a normal force applied to the center axis.

Blade #3 is in a stable 2 state with minimal drag but during the rotating of the frame, it will enter into an unstable state then flip over and settle to a stable 3 state. Total tangential forces applied to the arms is F2t for torque generation of VWTWRB.

FIG. 9 represents the frame after another 22.5° rotation and blade #1 is at 67.5° reference point. FIG. 9 is similar to FIG. 6 but with incident wind forces F2, F3, F4 changed following the rotation of the frame. Total tangential forces applied to the frame is a vector sum of F1t+F2t+F3t for torque generation of VWTWRB.

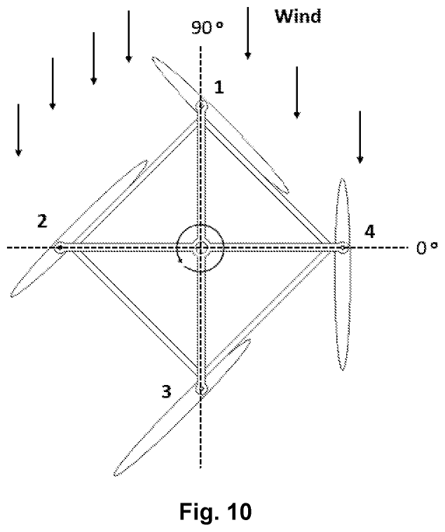

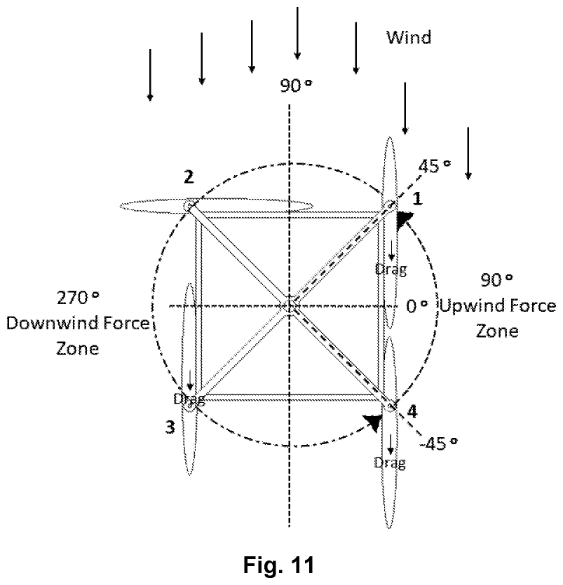

FIG. 10 represents a new cycle starting when blade #4 enters 0° to replace blade #1.

FIG. 11 represents a VWTWRB embodiment to be divided into two angular zones. For a blade rotating into an upwind force zone from −45° to 45° with a 90° angular span, it is in a stable 1 state with 0° AOA towards the wind. The blade encounters minimal drag and reduced upwind force.

For a blade rotating into a downwind force zone from 45° to −45° with a 270° angular span, it is in a stable 2 or stable 3 state. The AOA of the blade towards incident wind will change and it will generate a sinusoidal variable tangential force applying to the arm for VWTWRB rotation.

Locations of the beams are used to stop blades at a setting angle and the setting angle is used to set a ratio of upwind force zone versus downwind force zone. For a setting angle smaller than 45°, the upwind force zone would expand while downwind force zone contracts and, as a result, the ratio increases. Otherwise, for a setting angle larger than 45°, the ratio decreases.

The ratio is used to optimize the real-world efficiency of the VWTWRB. Static analysis is used to explain the principle of VWTWRB, but in real-world, off centrifugal force and aerodynamic force are wind speed dependable and complicate to determine. The ratio can be determined by computer simulation or real-world tests for optimal efficiency of the VWTWRB.

Said VWTWRB uses an elongated cube shaped frame with four blades to describe the VWTWRB principle; same principle can implement to wind turbine with cylindrical (or alternative shapes) frame, and any number of blades.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope, which is set forth in the following claims.

What is claimed is:

1. A Vertical Wind Turbine with Rotatable Blades (VWTWRB) comprising:
a center axis;
a turbine frame assembly;
wherein said turbine frame assembly comprises;
a turbine frame;
four wind blade subassemblies;
wherein each said wind blade subassembly comprises;
a pivot axis;
a wind blade;
Said VWTWRB uses wind power to drive the blades to rotate and stop at their designated positions for reducing the upwind force of the wind turbine.

2. The VWTWRB as in claim 1, wherein each said wind blade subassembly;
a pivot axis passing through the wind blade mounting hole and the wind blade is rotatable around the pivot axis.

3. The wind blade subassembly as in claim 2, wherein said wind blade;
the pivot axis divides the wind blade into two unequal area of airfoils; a larger area trail end and a smaller area lead end of the blade.

4. The wind blade as in claim 3, wherein said unequal area airfoils;
aerodynamic center of the blade is located within the larger area trail end, said area trail end dominates the rotation of the blade around the pivot axis by wind pressure.

5. The VWTWRB as in claim 1, wherein said turbine frame;
vertical beams of the frame stop the wind blades at specified locations to form the setting angle between the chord line of the blade and the arms.

6. Turbine frame as in claim 5, wherein said setting angle;
Setting angle is used to set the ratio of upwind force zone versus downwind force zone for optimal efficiency of the turbine In real-world applications.
